(19) United States
(12) Patent Application Publication
(10) Pub. No.: US 2005/0117546 A1
(43) Pub. Date: Jun. 2, 2005

(54) Method and apparatus for supporting inter-technology handoffs with Mobile IP

(76) Inventors: Marcello Lioy, San Diego, CA (US); Nischal Abrol, San Diego, CA (US); Oliver Michaelis, San Diego, CA (US); Uppinder S. Babbar, San Diego, CA (US)

Correspondence Address: Qualcomm Incorporated;Patents Department, 5775 Morehouse Drive, San Diego, CA, 92121-1714, US

(21) Appl. No.: 10/726,456

(22) Filed: Dec. 2, 2003

(51) Int. Cl. H04Q 7/00

(52) U.S. Cl. 370/332

(57) ABSTRACT

For Mobile IP supporting inter-technology handoffs, a logical interface is provided at an abstraction layer, which resides between a network layer and a link layer. The logical interface performs processing to provide an interface between the network layer and the link layer, but communicates with physical interfaces instead of directly with the link layer. One physical interface is provided for each communication network (e.g., each radio network of a different wireless technology). Each physical interface performs technology-dependent processing for the associated communication network and communicates with a respective link layer module. Each link layer module performs link layer processing for the associated communication network. The logical interface is associated with one physical interface at any given moment. The logical interface is also associated with an IP address that does not change and is used by IP in the network layer for communication with the multiple communication networks.

### BACKGROUND

I. Field

The present invention relates generally to communication, and more specifically to techniques for supporting inter-technology handoffs with mobile Internet Protocol (Mobile IP). II. Background

In an Internet Protocol (IP) network, a host communicates with another host via a router. In IP terminology, a “node” is a device that implements IP, a “router” is a node that forwards IP packets not explicitly addressed to itself, and a “host” is a node that is not a router. A host may have one or multiple interfaces to a link. In IP terminology, a “link” is a communication facility or medium over which nodes can communicate at a link layer (which is the layer immediately below IP), and an “interface” is a node's attachment to a link. Each interface is typically associated with an IP address that uniquely identifies that interface.

A wireless communication network may support voice and/or data services. Data communication may be achieved by using IP over the air-link interface protocols employed by the wireless network. A wireless terminal (a host) can establish a data session with the wireless network and communicate with a network entity (a router) in order to exchange data with other hosts coupled to the Internet. The terminal may be mobile and may communicate with different wireless networks of the same technology as it moves about. These wireless networks may be operated by the same or different network operators.

Mobile IP is a set of protocols and mechanisms that supports roaming for a mobile terminal (i.e., a mobile host) by allowing the terminal to maintain a fixed IP address even as the terninal's point of attachment to the Internet changes (e.g., due to roaming between different wireless networks). Mobile IP provides two mechanisms to support registration when the mobile terminal moves between wireless networks. For the first mechanism, when the mobile terminal detects that it has moved from its home network to a foreign network, the terminal obtains a care-of IP address for a foreign agent (FA) in the foreign network and registers the care-of address with its home agent (HA) in the home network. Thereafter, packets sent to the terminal's fixed IP address are intercepted by the home agent, forwarded by the home agent to the foreign agent using the care-of address, and then delivered by the foreign agent to the terminal. For the second mechanism, which is used if the foreign network does not have foreign agents, the terminal acts as its own foreign agent, obtains a dedicated IP address from the foreign network, and uses this IP address as its care-of address. Thereafter, packets sent to the terminal's home address are intercepted by the home agent and forwarded by the home agent directly to the terminal using the care-of address. Mobile IP for Internet Protocol Version 4 (IPv4) is described in RFC 3344, entitled “IP Mobility Support for IPv4,” August 2002, which is publicly available.

Mobile IP is conventionally implemented for a single wireless technology and allows a mobile terminal to roam among wireless networks of the same technology. A multi-mode terminal may be able to communicate with wireless networks of different technologies. Such wireless networks may include, for example, a Code Division Multiple Access (CDMA) network that implement IS-2000, IS-95, and/or IS-856 (also commonly referred to as a cdma2000 network), a Wideband CDMA (W-CDMA) network, a Global System for Mobile Communications (GSM) network, an IEEE 802.11-based network, and so on.

Supporting Mobile IP for multiple wireless technologies is challenging because IP addresses are conventionally assigned to specific air-link interfaces. If the multi-mode terminal communicates with multiple air-link interfaces of different wireless technologies, then the terminal would need to deal with multiple IP addresses assigned for these air-link interfaces. This can complicate the processing at the terminal for data transmission and reception, as described below.

There is therefore a need in the art for techniques to support inter-technology handoffs.

### SUMMARY

Techniques for supporting inter-technology handoffs with Mobile IP are provided herein. These techniques may be used for a multi-mode terminal that can communicate with multiple communication networks of different link-layer technologies (e.g., radio networks of different wireless technologies). The different link-layer technologies may include cdma2000, UMTS, IEEE 802.11, Ethernet, and so on, or a combination thereof. For Mobile IP supporting inter-technology handoffs, a logical interface is provided at an abstraction layer, which resides between a network layer and a link layer. One physical interface is provided for each communication network. Each physical interface communicates with a respective link layer module.

The logical interface performs processing to provide an interface between IP in the network layer (or simply, the IP layer) and the link layer. However, the logical interface communicates with the physical interfaces instead of directly with the link layer. Each physical interface is associated with a physical link which performs the necessary processing for a particular link-layer or wireless technology. For example, a physical interface may be associated with a physical link which performs the processing for the IEEE 802.11 protocol stack. Each link layer module implements all of the link layer protocols for a particular wireless technology. For example, a link layer module may implement PPP, LAC, and MAC for cdma2000.

The logical interface is associated with one physical interface at any given moment. The associated physical interface is the active physical interface for the communication network with which the multi-mode terminal is currently in communication. The logical interface is also associated with an IP address that does not change, regardless of which physical interface is associated with the logical interface. The IP layer uses the IP address of the logical interface for communication with the multiple communication networks.

On the transmit data path, the logical interface receives an IP packet from the IP layer and processes the packet in accordance with its configuration. The configuration of (and the processing by) the logical interface may be dependent on the capabilities and requirements of the physical interface currently associated with the logical interface. The logical interface then determines/identifies the physical interface that it is currently associated with and passes the processed packet to this physical interface.

On the receive data path, the active physical interface receives an IP packet from the associated link layer module and processes the packet in accordance with its configuration. The physical interface then determines if there is one or more logical interfaces associated with it and queries to determine which logical interface the data should be delivered to. The physical interface (1) passes the packet to the logical interface indicating it is the intended recipient or (2) passes the packet directly to the IP layer if no logical interface is the expected recipient. If the packet is passed to a logical interface, then the packet is further processed in accordance with that logical interface's configuration and then passed to the IP layer (or another logical interface if one is associated which the current interface).

The abstraction layer may include multiple layers of logical interfaces, and each such layer may include one or multiple logical interfaces. The association between the logical interfaces and the physical interfaces, the processing for the transmit data path, and the processing for the receive data path are described below.

Various aspects and embodiments of the invention are described in further detail below.

### BRIEF DESCRIPTION OF THE DRAWINGS

The features and nature of the present invention will become more apparent from the detailed description set forth below when taken in conjunction with the drawings in which like reference characters identify correspondingly throughout and wherein:

FIG. 1 shows a multi-mode terminal capable of communicating with multiple radio networks of different wireless technologies;

FIG. 2 shows a protocol stack for a data session between the multi-mode terminal and a cdma2000 network;

FIG. 3 shows a protocol stack for the multi-mode terminal;

FIG. 4 illustrates IP address selection for packet transmission using multiple network interfaces with different IP addresses;

FIG. 5 shows an embodiment of Mobile IP that supports inter-technology handoffs between multiple radio networks of different wireless technologies;

FIG. 6 illustrates the use of a logical interface with a single IP address for communication with multiple radio networks;

FIG. 7 shows a process performed by the logical interface for the transmit data path;

FIG. 8 shows a process performed by the logical interface or a physical interface for the receive data path;

FIG. 9 shows a process for configuring the logical interface; and

FIG. 10 shows a block diagram of the multi-mode terminal.

### DETAILED DESCRIPTION

The word “exemplary” is used herein to mean “serving as an example, instance, or illustration.” Any embodiment or design described herein as “exemplary” is not necessarily to be construed as preferred or advantageous over other embodiments or designs.

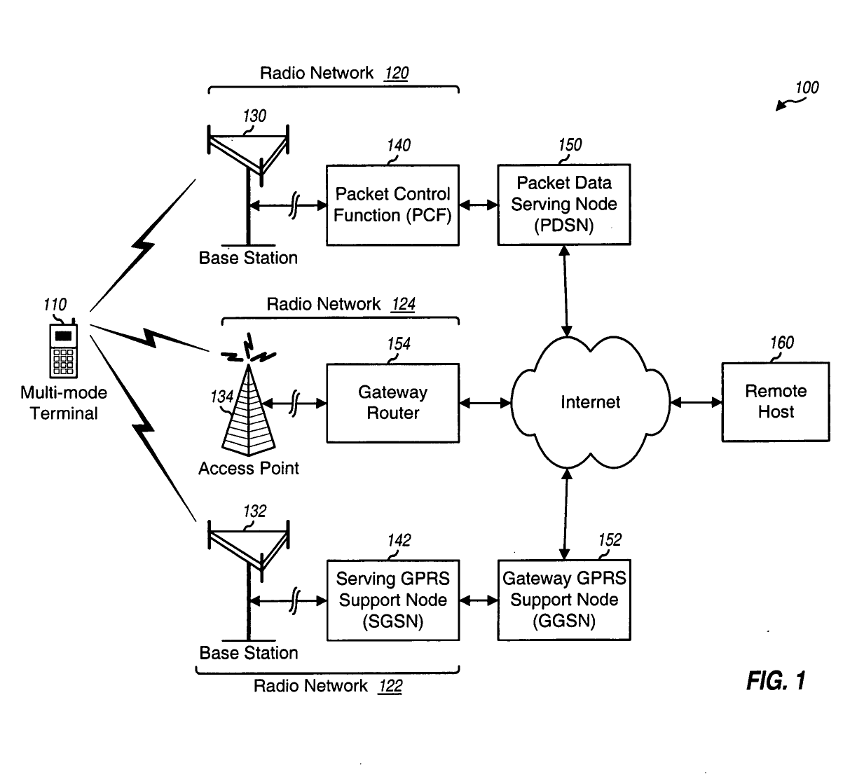

FIG. 1 shows a deployment 100 in which a wireless multi-mode terminal 110 can communicate with multiple radio networks 120, 122, and 124 of different wireless technologies. Terminal 110 may be a cellular phone or some other wireless communication device.

Radio network 120 may be, for example, a cdma2000 network that includes network entities described by a consortium named “3rd Generation Partnership Project 2” (3GPP2). A cdma2000 network may implement IS-2000, IS-856, and/or other 3GPP2 standards. Terminal 110 may communicate with a base station 130 in radio network 120 via an air-link connection. For packet data services, base station 130 communicates with a Packet Control Function (PCF) 140, which further communicates with a Packet Data Serving Node (PDSN) 150. PCF 140 is an entity in radio network 120 which controls the transmission of packets between base station 130 and PDSN 150. PDSN 150 supports packet data services for the terminals in the cdma2000 network. For example, PDSN 150 is responsible for the establishment, maintenance, and termination of a PPP (Point-to-Point Protocol) session towards the terminals. PPP is well known in the art. PDSN 150 may also assign dynamic IP addresses to the terminals. PDSN 150 couples to the Internet and can communicate with other entities (e.g., a remote host 160) that also couple to the Internet.

Radio network 122 may be, for example, a Universal Mobile Telecommunications System (UMTS) communication network that includes network entities described by a consortium named “3rd Generation Partnership Project” (3GPP). Terminal 110 may communicate with a Node B 132 in radio network 122 via an air-link connection. For packet data services, Node B 132 communicates with a Serving GPRS Support Node (SGSN) 142, which further communicates with a Gateway GPRS Support Node (GGSN) 152. SGSN 142 controls the transmission of packets between Node B 132 and GGSN 152. GGSN 152 supports packet data services for the terminals in the UMTS network.

Radio network 124 may be, for example, an IEEE 802.11-based network that includes an access point 134 and a gateway router 154. Terminal 110 may communicate with access point 134 via an air-link connection. Gateway router 154 supports packet data services for the terminals in the 802.11-based network and couples to the Internet.

In general, multi-mode terminal 110 may have the capability to communicate with any number of radio networks of different wireless technologies. Each radio network may be a wireless wide area network (WWAN) (e.g., a cdma2000 or UMTS network) or a wireless local area network (WLAN) (e.g., an 802.11-based network). Three exemplary radio networks for three different wireless technologies (cdma2000, UMTS, and 802.11) are shown in FIG. 1. The techniques described herein may be used for various combinations of radio networks. For clarity, the techniques are described below for a multi-mode terminal that can communicate with a cdma2000 network and an 802.11 network (i.e., radio networks 120 and 124 in FIG. 1).

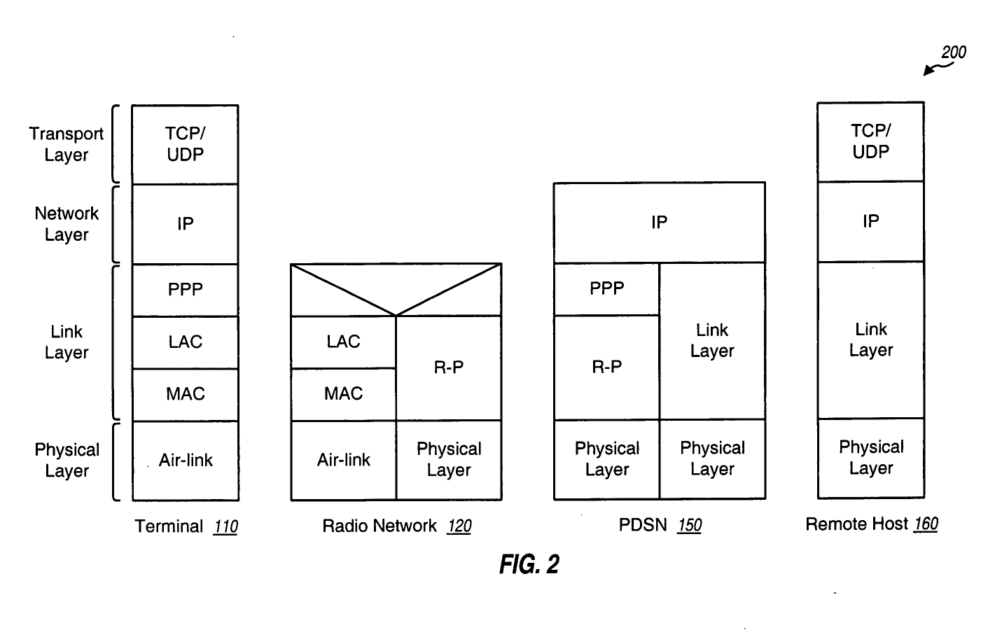

FIG. 2 shows a protocol stack 200 for a data session between multi-mode terminal 110 and the cdma2000 network for data exchange with remote host 160. Terminal 110 and remote host 160 may communicate via a transport layer, which may be implemented with Transmission Control Protocol (TCP), User Datagram Protocol (UDP), or some other protocol. TCP and UDP are well known in the art. The transport layer operates on top of a network layer, which is implemented with IP. Transport layer data is encapsulated in IP packets that are exchanged between terminal 110 and remote host 160 via PDSN 150. With IP, which is a connection-less protocol, each IP packet travels independently from the source node until it arrives at the destination node.

The network layer operates on top of a data link layer (or simply, the link layer), which is typically dependent on the wireless technology. For the cdma2000 network, the link layer is implemented with PPP, a Link Access Control (LAC) protocol, and a Media Access Control (MAC) protocol. Terminal 110 maintains a PPP session with PDSN 150 for the data session. For data exchange, terminal 110 communicates with radio network 120 via the LAC and MAC protocols that operate on top of an air-link protocol. Radio network 120 communicates with PDSN 150 via a radio network-PDSN (or simply, “R-P”) interface that operates on top of a physical layer. The R-P interface is described in IS-41, which is publicly available. PDSN 150 communicates with remote host 160 via IP over a link layer and a physical layer.

FIG. 2 shows the protocol stack for a data session with the cdma2000 network. The protocol stacks for data sessions with other radio networks of different wireless technologies are likely to be different from the one shown in FIG. 2. For example, an 802.11 network utilizes a different link layer than the one shown in FIG. 2. The protocol stack typically includes other layers on top of the transport layer, which are not shown in FIG. 2. For simplicity, the layers above the network layer (IP) are omitted in the following description.

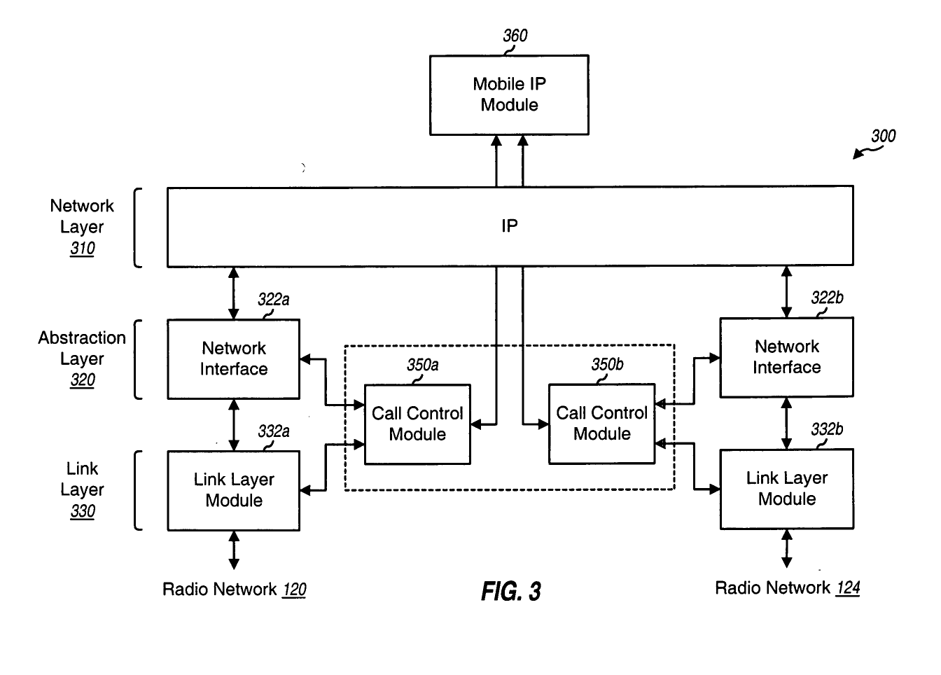

FIG. 3 shows an exemplary protocol stack 300 for multi-mode terminal 110. Protocol stack 300 includes a network layer 310 (e.g., implemented with IP), an “abstraction” layer 320, and a link layer 330.

Wireless networks typically use abstraction layer 320 to provide a generic interface between the network layer (which is typically IP) and the underlying link layer (which is typically wireless technology dependent). Abstraction layer 320 allows IP to operate over link layers for different wireless technologies without having to know the details of the underlying wireless technology. For example, the frame formats for PPP for cdma2000 are different from the frame formats for 802.11. Abstraction layer 320 includes a network interface 322 for each wireless technology. Each network interface 322 provides the interface between the IP layer and the link layer for the wireless technology. This way, the IP layer can use the same Application Program Interface (API) for calls into different network interfaces, which mask the differences between the link layer technologies.

One network interface 322 is provided for each radio network of a different wireless technology. For the example shown in FIG. 3, multi-mode terminal 110 includes network interfaces 322a and 322b for radio networks 120 and 124, respectively. Each network interface 322 operates between the IP layer and an associated link layer module 332. Each link layer module 332 implements all of the link layer protocols for the wireless technology supported by the associated network interface. For example, a link layer module 332a implements PPP, LAC, and MAC for cdma2000, and a link layer module 332b implements the link layer protocols for 802.11.

A call control module 350 is typically provided for each radio network of a different wireless technology. For the example shown in FIG. 3, multi-mode terminal 110 includes call control modules 350a and 350b for radio networks 120 and 124, respectively. Each call control module 350 configures, enables, and disables network interface 322 and link layer module 332 for the associated radio network. At the start of a data session with a radio network, call control module 350 for the radio network performs the necessary registration and overhead processing to configure and enable network interface 322 and link layer module 332 for the radio network. As part of the data session establishment, call control module 350 obtains an IP address for network interface 322 via Mobile IP registration, which may be different for different radio networks. For example, the IP address is obtained via PPP negotiation for cdma2000 and via overhead signaling for UMTS. Call control module 350 effectively “owns” the associated network interface 322. Call control modules 350a and 350b provide control functions for interfaces and modules that implement the protocol stack. However, call control modules 350a and 350b are not part of the protocol stack, as indicated by a dashed box around these modules.

A Mobile IP module 360 supports Mobile IP for multiple radio networks of different wireless technologies. Mobile IP module 360 communicates with call control modules 350a and 350b to determine which network interface is active and should be used for communication. Mobile IP module 360 may also communicate with the IP layer.

Conventionally, IP addresses are assigned to network interfaces 322. Typically, an IP address is assigned to terminal 110 (a device) by a radio network. Since different network interfaces are used for different radio networks, the IP addresses are effectively tied to the network interfaces.

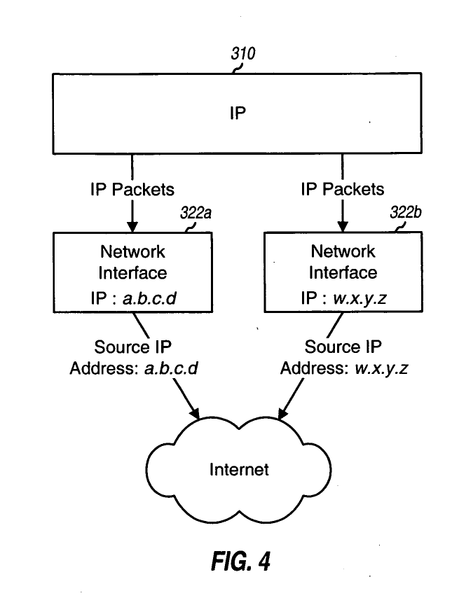

FIG. 4 illustrates IP address selection for packet transmission using multiple network interfaces 322a and 322b with different IP addresses. For this example, network interface 322a is assigned an IP address of a.b.c.d, and network interface 322b is assigned an IP address of w.x.y.z. The IP layer can send IP packets via network interface 322a or 322b. An entity within terminal 110 determines which network interface is active and can be used for packet transmission. Only one network interface (if any) is typically active at any given moment. The active network interface is the network interface for the radio network with which the terminal currently communicates. The IP layer uses the IP address of the active network interface as the source address for each IP packet to be sent. Different IP addresses are used for packet transmission depending on which network interface is active. The IP address used by the IP layer changes whenever there is a handoff from one radio network to another radio network.

In order to support the use of a single IP address for multiple network interfaces for multiple radio networks of different wireless technologies, the following challenges need to be overcome.

First, the Mobile IP module would need to be able to disable the IP address from one network interface and configure the same IP address on another network interface. This requires the Mobile IP module to be aware of the status of the network interfaces (e.g., which network interface is enabled, which network interface is preferred or optimal, and so on). As shown in FIG. 3, a separate call control module is typically provided for each radio network, and this module enables and disables the network interface for the radio network. The call control module and/or other modules may need to perform other actions when network interfaces are enabled and disabled because of system changes (e.g., a handoff from the cdma2000 network to the 802.11 network). To disable and configure IP address, the Mobile IP module would need to operate as a controller for these network interfaces, which already have their own controllers. To avoid an undesirable scenario with multiple controllers configuring the same network interfaces, the enabling/disabling of network interfaces should be performed by the call control module instead of the Mobile IP module.

Second, directly modifying the assignment of IP address to network interface can affect routing efficiency. To streamline the transmit data path, it is desirable to avoid doing routing lookup for each packet sent from the IP layer. One method of achieving this for a connected socket (such as TCP) is to perform a routing lookup the first time a packet is sent from the IP layer, determine the network interface to use, and store this information in a routing cache. (A socket is a network programming API.) Subsequent packets to be sent via this network interface are then processed using information stored in the routing cache, thus avoiding the routing lookup. This optimization is not possible if the Mobile IP module directly modifies network interfaces because the network interface corresponding to the IP address will change after a handoff, which would invalidate the routing cache. To address this problem, the routing cache for all connected sockets would have to be flushed whenever a handoff occurs. However, this requirement will complicate handoff (since the Mobile IP module would need to have socket information in order to flush the routing cache) and further add significant overhead to the data path after the handoff.

Third, the architecture shown in FIG. 3 does not easily support different modes of operation for Mobile IP. Different Mobile IP registration mechanisms may be required for different radio networks that support different Mobile IP modes of operation. For a radio network that has foreign agents (e.g., a cdma2000 network), the terminal registers and operates in an FA mode and uses the foreign agent to exchange IP packets. For a radio network that does not have foreign agents (e.g., an 802.11 network), the terminal registers and operates in a co-located mode, without the benefit of the foreign agents. Different operating modes have different requirements. For example, operation in the co-located mode requires the network interface to support tunneling IP in IP, which typically requires the use of logical interfaces (described below). If the Mobile IP module is directly manipulating the network interfaces, then it is difficult to change the operation mode that the Mobile IP module is using on the fly.

For the above reasons, it is difficult to implement Mobile IP for multiple radio networks of different wireless technologies using the architecture shown in FIG. 3.

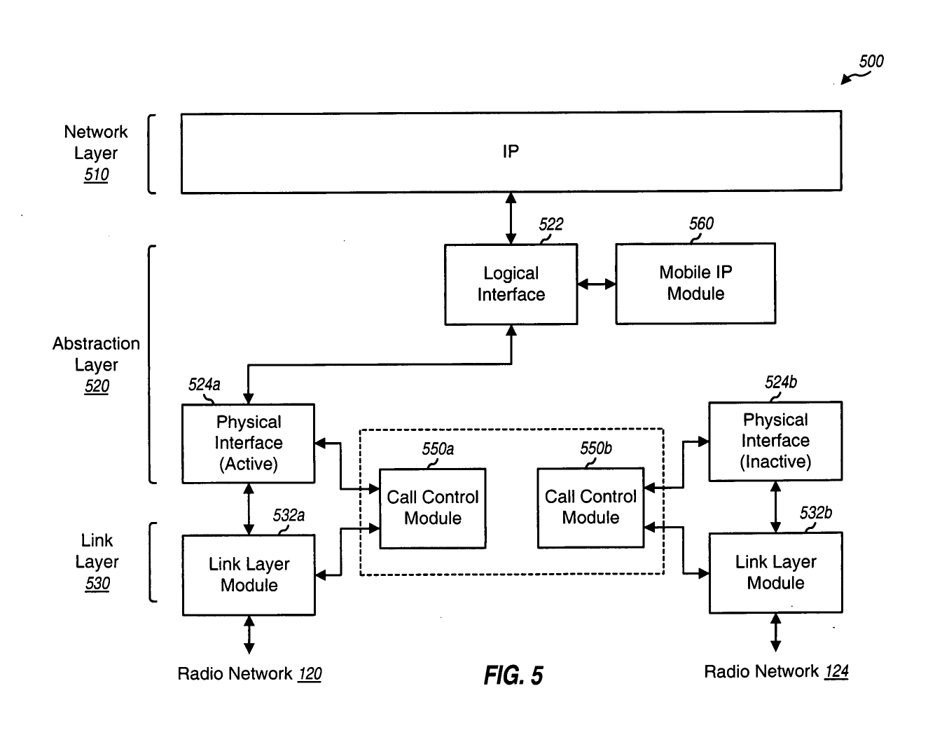

FIG. 5 shows a diagram of an embodiment of Mobile IP that supports inter-technology handoffs between multiple radio networks of different wireless technologies. A protocol stack 500 for multi-mode terminal 110 includes a network layer 510 (e.g., IP), an abstraction layer 520, and a link layer 530.

For this embodiment, Mobile IP is supported via one or more layers of logical interfaces in abstraction layer 520. For clarity, the simple case of one layer with one logical interface 522 is described below. A logical interface is an interface that can perform the processing of a network interface but does not communicate directly with the link layer. Logical interface 522 resides on top of and communicates with physical interfaces 524a and 524b. A physical interface is an interface for the link-layer associated with a device (e.g., PPP for the CDMA2000 air interface) and which performs the necessary processing for a wireless technology supported by the device. For example, a physical interface abstracts the link-layer processing for the 802.11 protocol stack. Physical interfaces 524a and 524b communicate with link layer modules 532a and 532b, respectively, in link layer 530.

Logical interface 522 is associated with only one physical interface 524 at any given moment and communicates only with the associated physical interface. Each physical interface 524 communicates with an associated link layer module 532. Each physical interface 524 and its associated link layer module 532 collectively support one radio network of a particular wireless technology.

A Mobile IP module 560 determines the association between logical interface 522 and physical interfaces 524a and 524b. Mobile IP module 560 determines which physical interface is currently active and associates its logical interface 522 with the active physical interface. Only one physical interface is typically active at any given moment. However, multi-mode terminal 110 may be designed with the capability to communicate with multiple radio networks simultaneously, in which case multiple physical interfaces may be active concurrently. For simplicity, the following description assumes that only one physical interface is active at any given moment.

Mobile IP module 560 may receive information indicating which physical interface 524 is currently active from entities within terminal 110 (e.g., call control modules 550a and 550b). Mobile IP module 560 may also poll call control modules 550a and 550b, physical interfaces 524a and 524b, and/or link layer modules 532a and 532b to discover the active physical interface. Mobile IP module 560 then associates logical interface 522 with the active physical interface. Mobile IP module 560 does not need to directly manipulate the physical interfaces, but rather just configure logical interface 522 to change its association to the proper physical interface.

Physical interfaces 524a and 524b are configured by a logical interface controller, which is Mobile IP module 560 in this case, to interact with the associated logical interface 522. Each call control module 550 determines whether or not there is communication with the associated radio network. A control module (not shown in FIG. 5) may receive information from call control modules 550a and 550b and determine which radio network to process, which call control module and physical interface to enable, and which call control module and physical interface to disable. This control module may provide information for the active physical interface to Mobile IP module 560.

The IP address for logical interface 522 may also be a permanent IP address for multi-mode terminal 10 or may be obtained in some other manner. The IP address for logical interface 522 does not change even as multi-mode terminal 110 is handed off from one radio network to another radio network. One IP address may then be used for multiple radio networks of different wireless technologies.

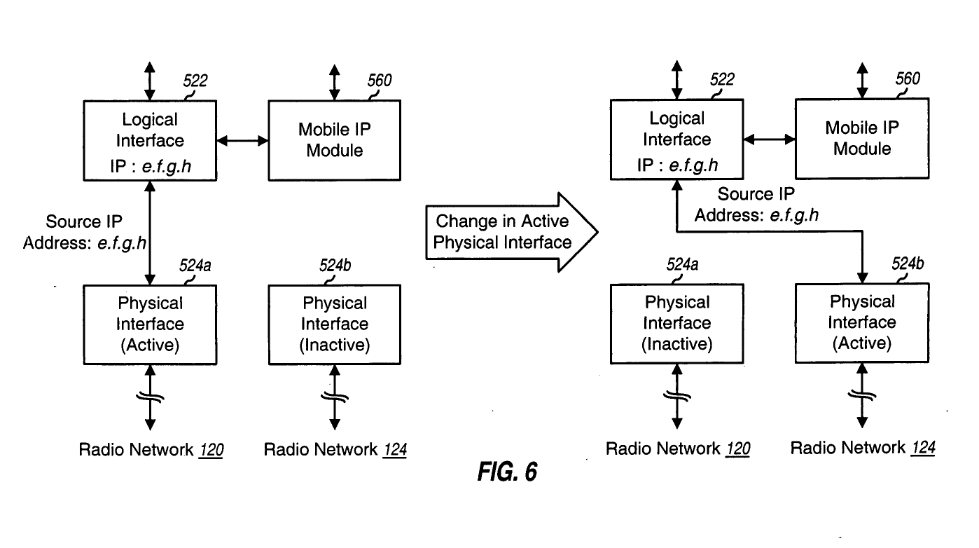

FIG. 6 illustrates the use of logical interface 522 with a single IP address for communication with multiple radio networks of different wireless technologies. For this example, logical interface 522 is assigned an IP address of e.f.g.h. During a first time period, physical interface 524a for the first radio network is active. Mobile IP module 560 receives this information from another entity within terminal 110 and associates logical interface 522 with the active physical interface 524a. The IP address e.f.g.h is used for IP packets exchanged between logical interface 522 and radio network 120 via physical interface 524a. During a second time period, physical interface 524b for radio network 124 becomes active. Mobile IP module 560 receives information for the change in active radio network and associates logical interface 522 with this active physical interface 524b. The same IP address e.f.g.h is used for IP packets exchanged between logical interface 522 and radio network 124 via physical interface 524b.

For simplicity, FIGS. 5 and 6 show one logical interface 522 and two physical interfaces 524a and 524b. In general, multi-mode terminal 110 may include any number of logical interfaces. Each logical interface is associated with an instance of Mobile IP. Multiple Mobile IP instances (or one overall Mobile IP) may be provided for multiple logical interfaces. Each logical interface is associated with a respective IP address. Multi-mode terminal 110 may also include any number of physical interfaces, one or more physical interfaces for each radio network with which the terminal can communicate. For example, terminal 110 may have multiple simultaneous calls, where each call may be associated with a different IP address and each IP address may have an associated physical interface.

When multiple interfaces are present, the IP layer selects a specific interface to use for a transmission of a datagram. The IP layer processes packets to be sent using the IP address of the selected interface. This functionality is applicable to both physical and logical interfaces. If an application is using the IP address associated with a logical interface, then the socket associated with that application will have that logical interface in its routing cache. The socket's routing cache need not be flushed when multi-mode terminal 110 is handed off from radio network to another radio network. This is because the logical interface will remain the same and will change its associated physical interface.

Also for simplicity, FIGS. 5 and 6 show only one layer of logical interfaces. In general, abstraction layer 520 may include any number of layers of logical interfaces. Each logical interface is associated with one logical interface or one physical interface in the layer directly below. Each logical interface may be associated with zero, one, or multiple logical interfaces in the layer directly above. Each logical interface in the layer directly above the physical interfaces is associated with one physical interface. Each logical interface in a layer not directly above the physical interface layer is also indirectly associated with one physical interface via one or more intervening logical interfaces in the layer(s) in between. Zero, one, or multiple logical interfaces may be associated with a given physical interface at any given moment. There is thus a one-to-one association between logical interface to physical interface, a one-to-many association between physical interface to logical interfaces, and a one-to-one association between physical interface, link layer module, and radio network.

Each logical interface and each physical interface maintains a list of all associated logical interfaces (if any) in the layer directly above. Each logical interface also maintains the identity of the associated logical/physical interface in the layer directly below. An association list for each logical/physical interface contains all association information for the interface. Each logical interface is also configured by Mobile IP module 560 to process packets received by the logical interface on the transmit and receive data paths in accordance with a configuration for the logical interface. This configuration may be dependent on various factors such as the capabilities and requirements of the associated physical interface.

Each logical interface may or may not perform processing on IP packets on the transmit data path. Moreover, each logical interface may or may not perform processing on IP packets on the receive data path. Whether or not to perform processing, and the specific processing to be performed, are dependent on several factors such as (1) the capabilities and requirements of the associated physical interface, which are dependent on the wireless technology, (2) whether the packet is for the transmit or receive data path, and (3) possibly other factors.

As noted above, Mobile IP may be operated in an FA mode if the radio network has foreign agents or a co-located mode if the radio network does not have foreign agents. In the FA mode, the physical interface is not associated with an IP address, and the logical interface is associated with the fixed IP address. On the receive data path in the FA mode, the physical interface receives IP packets from a foreign agent in the radio network and passes the packets to the logical interface. In the co-located mode, the physical interface is associated with a care-of address and the logical interface is associated with the fixed IP address. In this mode, the physical interface or a designated logical interface can perform encapsulation and decapsulation for IP packets with the care-of address. IP packets without the encapsulation header are exchanged with the IP layer.

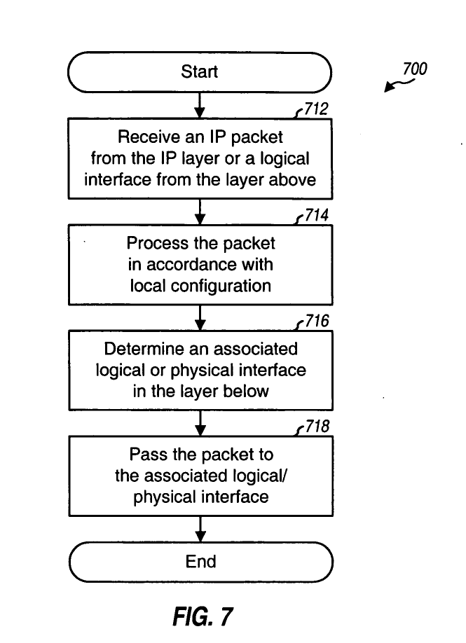

FIG. 7 shows a flow diagram of a process 700 performed by logical interface 522 for the transmit data path. Logical interface 522 receives an IP packet from the layer directly above (not shown in FIGS. 5 and 6) which could be the IP layer or another logical interface (step 712). Logical interface 522 processes the packet in accordance with its local configuration, which is configuration that is specific to the interface (step 714). The processing is dependent on various factors (e.g., the capabilities and requirements of the associated physical interface). For example, logical interface 522 may perform encapsulation when operating in the co-located mode. Logical interface 522 may also perform no processing and simply pass the packet down to the next lower layer. In any case, after all required processing has been performed, logical interface 522 determines the physical or logical interface in the layer directly below that is associated with logical interface 522 (step 716). Logical interface 522 then passes the packet to the associated logical or physical interface (step 718).

Steps 716 and 718 may be implicitly performed if logical interface 522 is configured with the association. For example, a transmit function for logical interface 522 may be set to a receive function for the associated physical interface by Mobile IP module 560. In this case, the packet is automatically sent to the proper physical interface when logical interface 522 passes the packet down to the next lower layer.

On the transmit data path, the IP layer sends IP packets to the selected logical interface in the topmost layer. The IP layer uses the IP address assigned to the selected logical interface, which does not change regardless of the configuration for the layers below (e.g., regardless of which physical interface is currently active). Because of the one-to-one association between a logical interface to a logical/physical interface in the layer below, the packets are forwarded (i.e., funneled) to the proper physical interface. This is achieved without the need for the IP layer to be aware of which physical interface is active.

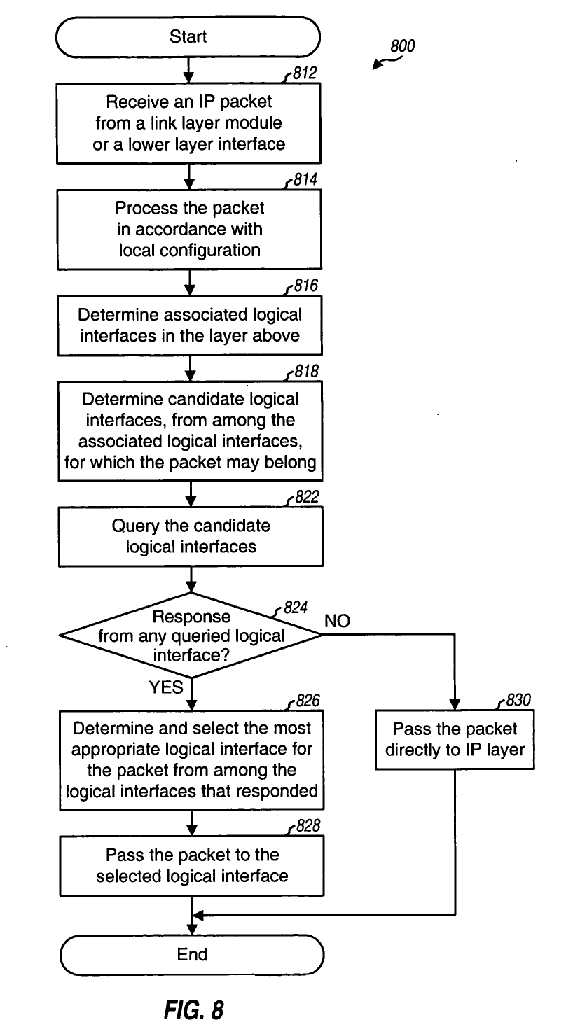

FIG. 8 shows a flow diagram of a process 800 performed by an interface 523, which may be logical interface 522 or an active physical interface 524, for the receive data path. Interface 523 receives an IP packet from a link layer module 532 or a logical or physical interface in the layer directly below (step 812). Interface 523 processes the received packet in accordance with the configuration set for interface 523 (step 814). Again, the processing is dependent on various factors (e.g., the capabilities and requirements of the active physical interface). For example, interface 523 may perform decapsulation for the packet when operating in the co-located mode. Interface 523 may also perform no processing and simply pass the packet up to a higher layer.

Interface 523 then determines the logical interfaces (if any), in the layer directly above, that are associated with interface 523 (step 816). These logical interfaces are included in the association list for interface 523. Interface 523 then determines candidate logical interfaces, from among the associated logical interfaces, for which the packet may belong (step 818). Step 818 may be performed based on the IP address of the packet, the IP addresses of the associated logical interfaces, the processing to be performed for the packet, and so on. For example, if the packet is to be processed for IPsec, then only logical interfaces designated to perform IPsec processing are the ones for which the packet may belong.

Interface 523 then queries the candidate logical interfaces (if any) (step 822). A determination is then made whether or not interface 523 receives a response from a queried logical interface (step 824). If the answer is ‘yes’, then interface 523 determines and selects the most appropriate logical interface for the packet (step 826). Interface 523 then passes the packet to the selected logical interface (step 828). Otherwise, if no logical interfaces are associated with interface 523 or if no response is received for the query (i.e., the answer is ‘no’ for step 824), then interface 523 passes the packet directly to the IP layer (step 830).

Steps 824, 826, and 828 may be performed in various manners. For example, interface 523 may query one candidate logical interface at a time and pass the packet to the first logical interface that responds. As another example, interface 523 may query all candidate logical interfaces and select (1) the first logical interface to respond, (2) the logical interface that responded with the highest value that indicates the best match for the packet, and so on.

On the receive data path, packets are received by an active physical interface, processed, and passed up to the appropriate associated logical interfaces in the layers above. Because of the possible one-to-many association, a logical/physical interface queries the associated logical interfaces in the layer above to determine where to pass the packets. A packet may be sent to zero, one, or multiple logical interfaces above. A physical interface can also pass a packet directly to the IP layer if (1) there are no associated logical interfaces or (2) the associated logical interfaces did not respond to the query. The logical interfaces in the layer directly below the IP layer pass packets directly to the IP layer without querying (as expected given that there are no logical interfaces associated with it).

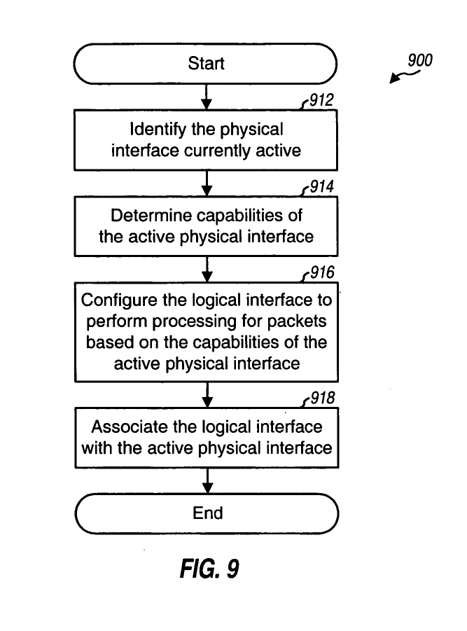

FIG. 9 shows a flow diagram of a process 900 performed by Mobile IP module 560 to configure logical interface 522. Initially, Mobile IP module 560 identifies the physical interface that is currently active (which is referred to as physical interface 524x in the following description) (step 912). Mobile IP module 560 may achieve this based on information provided by another entity within the terminal, by querying call control modules 550, and so on. Mobile IP module 560 then determines the capabilities and requirements of the active physical interface 524x (step 914). The capabilities may be determined by the radio network, the mode of operation (e.g., FA mode or co-located mode), and so on, or a combination thereof. Mobile IP module 560 then configures logical interface 522 to perform processing for packets based on the determined capabilities and requirements of the active physical interface 524x (step 916). Logical interface 522 would thereafter process packets in accordance with its configuration. Mobile IP module 560 then associates logical interface 522 with the active physical interface 524x (step 918).

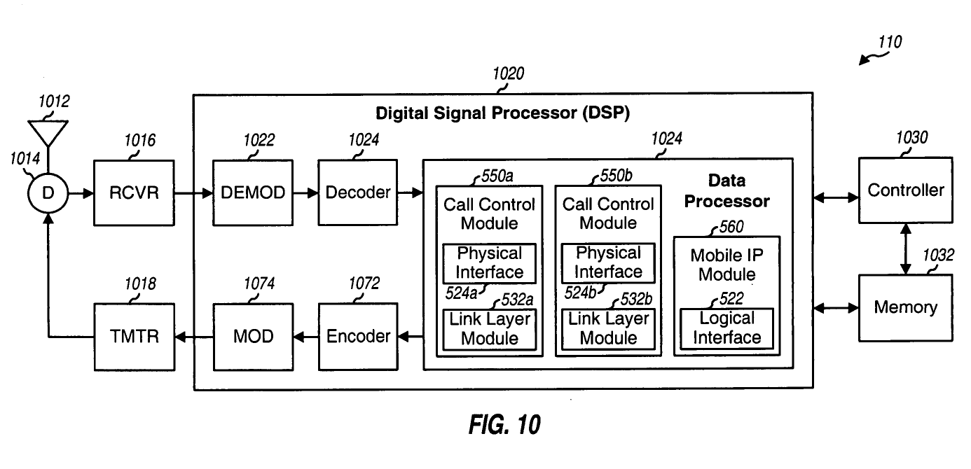

FIG. 10 shows a block diagram of an embodiment of multi-mode terminal 110. Terminal 110 is capable of bi-directional communication with multiple radio networks of different wireless technologies on the receive and transmit data paths.

For the receive path, signals transmitted by one or more radio networks are received by an antenna 1012, routed through a duplexer (D) 1014, and provided to a receiver unit (RCVR) 1016. Receiver unit 1016 conditions (e.g., filters, amplifies, and frequency downconverts) the received signal, digitizes the conditioned signal, and provides data samples to a digital signal processor (DSP) 1020. Within DSP 1020, a demodulator (DEMOD) 1022 processes the data samples and provides demodulated data. A decoder 1024 processes the demodulated data and provides decoded data for the physical layer. The processing by receiver unit 1016, demodulator 1022, and decoder 1024 is typically dependent on the radio network from which terminal 110 is receiving transmission (the active radio network).

A data processor 1040 performs processing for the link layer, the abstraction layer, and possibly higher layers. Data processor 1040 includes call control modules 550a and 550b and Mobile IP module 560. Each call control module 550 implements call control functions and configures physical interface 524 and link layer module 532 for an associated radio network. Mobile IP module 560 implements Mobile IP, configures logical interface 522, and associates logical interface 522 to the active physical interface.

Link layer module 532 for the active radio network performs link layer processing on the physical layer decoded data. The active physical interface 524 processes the packets from the associated link layer module 532 and provides processed packets to the associated logical interface 522, which further processes the packets and passes the processed packets to the IP layer. Data processor 1040 or some other unit performs processing for the IP layer.

For the transmit path, data to be transmitted from terminal 110 is processed at the IP layer (e.g., by data processor 1040) to obtain IP packets. Logical interface 522 and associated physical interface 524 and link layer module 532 further process the packets and provide processed packets to an encoder 1072. Encoder 1072 performs physical layer processing for the transmit data path and provides coded data. A modulator (MOD) 1074 processes the coded data and provides modulated data. A transmitter unit (TMTR) 1018 conditions the modulated data and generates a modulated signal, which is routed through duplexer 1014 and transmitted via antenna 1012.

A controller 1030 performs various processing functions for voice/data communication and further directs the operation of DSP 1020. A memory unit 1032 stores program codes and data for controller 1030.

The techniques described herein for supporting inter-technology handoffs with Mobile IP may be implemented by various means. For example, these techniques may be implemented in hardware, software, or a combination thereof. For a hardware implementation, the processing units used to perform the processing for Mobile IP (e.g., data processor 1040) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, these techniques may be implemented with modules (e.g., procedures, functions, and so on) that perform the functions described herein (e.g., processes 700, 800, and 900). The software codes may be stored in a memory unit (e.g., memory unit 1032 in FIG. 10) and executed by a processor (e.g., controller 1030). The memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method of supporting communication with a plurality of communication networks of different link-layer technologies, comprising:
receiving a first Internet Protocol (IP) packet at a logical interface;
processing the first IP packet in accordance with a configuration for the logical interface;
determining a first physical interface as being associated with the logical interface, wherein the first physical interface is one of a plurality of physical interfaces for the plurality of communication networks, and wherein the logical interface is configurable for association with any one of the plurality of physical interfaces; and
passing the processed first IP packet to the first physical interface.

2. The method of claim 1, wherein the plurality of communication networks are wireless communication networks of different wireless technologies.

3. The method of claim 1, wherein the first physical interface is for a first communication network among the plurality of communication networks, and wherein the logical interface is associated with the first physical interface for communication with the first communication network.

4. The method of claim 1, wherein the logical interface is associated with an IP address that remains unchanged regardless of which one of the plurality of physical interfaces is associated with the logical interface.

5. The method of claim 4, wherein the first IP packet includes the IP address of the logical interface as a source address.

6. The method of claim 4, wherein the processing includes encapsulating the first IP packet with the IP address of the logical interface.

7. The method of claim 1, wherein the configuration for the logical interface is dependent on a particular one of the plurality of physical interfaces associated with the logical interface.

8. The method of claim 1, further comprising:
receiving a second IP packet at the logical interface;
processing the second IP packet in accordance with the configuration for the logical interface;
determining a second physical interface as being associated with the logical interface, wherein the second physical interface is another one of the plurality of physical interfaces; and
passing the processed second IP packet to the second physical interface.

9. The method of claim 8, wherein the second physical interface is for a second communication network among the plurality of communication networks, and wherein the logical interface is associated with the second physical interface for communication with the second communication network.

10. The method of claim 1, wherein the plurality of communication networks include a cdma2000 wireless communication network.

11. The method of claim 1, wherein the plurality of communication networks include a W-CDMA wireless communication network.

12. The method of claim 1, wherein the plurality of communication networks include an IEEE 802.11-based wireless network.

13. An apparatus operable to support communication with a plurality of communication networks of different link-layer technologies, comprising:
a first physical interface operative to perform technology-dependent processing for a first communication network among the plurality of communication networks;
a second physical interface operative to perform technology-dependent processing for a second communication network among the plurality of communication networks; and
a logical interface operative to receive and process a first Internet Protocol (IP) packet in accordance with a configuration for the logical interface, determine that the first physical interface is associated with the logical interface, and pass the processed first IP packet to the first physical interface, wherein the logical interface is configurable for association with either the first or second physical interface.

14. The apparatus of claim 13, wherein the logical interface is further operative to receive and process a second IP packet in accordance with the configuration for the logical interface, determine that the second physical interface is associated with the logical interface, and pass the processed second IP packet to the second physical interface.

15. The apparatus of claim 13, wherein the logical interface is associated with an IP address that remains unchanged regardless of whether the first or second physical interface is associated with the logical interface, and wherein the first IP packet includes the IP address of the logical interface as a source address.

16. The apparatus of claim 13, further comprising:
a Mobile IP module operative to configure the logical interface and associate the logical interface with either the first or second physical interface.

17. An apparatus operable to support communication with a plurality of communication networks of different link-layer technologies, comprising:
means for receiving an Internet Protocol (IP) packet at a logical interface;
means for processing the IP packet in accordance with a configuration for the logical interface;
means for determining a physical interface associated with the logical interface, wherein the physical interface is one of a plurality of physical interfaces for the plurality of communication networks, and wherein the logical interface is configurable for association with any one of the plurality of physical interfaces; and
means for passing the processed IP packet to the physical interface.

18. A processor readable media for storing instructions operable in a wireless device to:
receive an Internet Protocol (IP) packet at a logical interface;
process the IP packet in accordance with a configuration for the logical interface;
determine a physical interface associated with the logical interface, wherein the physical interface is one of a plurality of physical interfaces for a plurality of communication networks with different link-layer technologies, and wherein the logical interface is configurable for association with any one of the plurality of physical interfaces; and
pass the processed IP packet to the physical interface.

19. A method of supporting communication with a plurality of communication networks of different link-layer technologies, comprising:
receiving an Internet Protocol (IP) packet at a physical interface, wherein the physical interface is one of a plurality of physical interfaces for the plurality of communication networks;
processing the IP packet in accordance with a configuration for the physical interface;
determining at least one logical interface associated with the physical interface, wherein each of the at least one logical interface is associated with a respective IP address and is configurable for association with any one of the plurality of physical interfaces;
querying the at least one logical interface; and
passing the processed IP packet to a selected logical interface among the at least one logical interface if a response to the query is received.

20. The method of claim 19, further comprising:
passing the processed IP packet to an IP layer if the response to the query is not received.

21. The method of claim 19, wherein the IP address for each of the at least one logical interface remains unchanged regardless of which one of the plurality of physical interfaces is associated with the logical interface.

22. The method of claim 19, further comprising:
determining one or more candidate logical interfaces, from among the at least one logical interface, for potentially processing the IP packet, and wherein the one or more candidate logical interfaces are queried.

23. The method of claim 22, wherein the one or more candidate logical interfaces are determined based on an IP address of the IP packet and the IP address of each of the at least one logical interface.

24. The method of claim 22, wherein the one or more candidate logical interfaces are determined based on processing to be performed on the IP packet.

25. The method of claim 19, further comprising:
receiving a response to the query from one of the at least one logical interface, and wherein the selected logical interface is the one logical interface with the response.

26. The method of claim 19, further comprising:
receiving responses to the query from at least two logical interfaces among the at least one logical interface; and
selecting one logical interface among the at least two logical interfaces as the selected logical interface.

27. The method of claim 26, wherein the one logical interface is selected based on the IP address of the one logical interface.

28. An apparatus operable to support communication with a plurality of communication networks of different link-layer technologies, comprising:
a first physical interface operative to perform technology-dependent processing for a first communication network among the plurality of communication networks; and
a second physical interface operative to perform technology-dependent processing for a second communication network among the plurality of communication networks, and
wherein each of the first and second physical interfaces is operative to receive and process Internet Protocol (IP) packets in accordance with a configuration for the physical interface, determine at least one logical interface associated with the physical interface, query the at least one logical interface, and pass the processed IP packets to a selected logical interface among the at least one logical interface, and wherein each of the at least one logical interface is associated with a respective IP address and is configurable for association with either the first or second physical interface.

29. An apparatus operable to support communication with a plurality of communication networks of different link-layer technologies, comprising:
means for receiving an Internet Protocol (IP) packet at a physical interface, wherein the physical interface is one of a plurality of physical interfaces for the plurality of communication networks;
means for processing the IP packet in accordance with a configuration for the physical interface;
means for determining at least one logical interface associated with the physical interface, wherein each of the at least one logical interface is associated with a respective IP address and is configurable for association with any one of the plurality of physical interfaces;
means for querying the at least one logical interface; and
means for passing the processed IP packet to a selected logical interface among the at least one logical interface if a response to the query is received.

30. A method of supporting communication with a plurality of communication networks of different link-layer technologies, comprising:
identifying a physical interface currently active and used for communication with a communication network among the plurality of communication network, wherein the physical interface is one of a plurality of physical interfaces for the plurality of communication networks;
determining capabilities of the physical interface;
configuring a logical interface to perform processing for Internet Protocol (IP) packets based on the determined capabilities of the physical interface; and
associating the logical interface with the physical interface.

31. The method of claim 30, wherein the capabilities of the physical interface is dependent on the communication network for which the physical interface is used for communication.

32. An apparatus operable to support communication with a plurality of communication networks of different link-layer technologies, comprising:
means for identifying a physical interface currently active and used for communication with a communication network among the plurality of communication networks, wherein the physical interface is one of a plurality of physical interfaces for the plurality of communication networks;
means for determining capabilities of the physical interface;
means for configuring a logical interface to perform processing for Internet Protocol (IP) packets based on the determined capabilities of the physical interface; and
means for associating the logical interface with the physical interface.
